(19) United States
(12) Patent Application Publication
(10) Pub. No.: US 2022/0004501 A1
(43) Pub. Date: Jan. 6, 2022

(54) JUST-IN-TIME SYNONYM HANDLING FOR A VIRTUALLY-TAGGED CACHE

(71) Applicant: Ampere Computing LLC, Santa Clara, CA (US)

(72) Inventors: John Gregory Favor, Santa Clara, CA (US); Stephan Jean Jourdan, Santa Clara, CA (US); Jonathan Christopher Perry, Santa Clara, CA (US); Kjeld Svendsen, Santa Clara, CA (US); Bret Leslie Toll, Santa Clara, CA (US)

(21) Appl. No.: 16/919,171

(22) Filed: Jul. 2, 2020

(51) Int. Cl. G06F 12/1045

(52) U.S. Cl. CPC G06F 12/1045; G06F 2212/684

(57) ABSTRACT

An apparatus configured to provide just-in-time synonym handling, and related systems, methods, and computer-readable media, are disclosed. The apparatus includes a first cache comprising a translation lookaside buffer (TLB) and a hit/miss block. The first cache is configured to form a miss request associated with an access to the first cache and provide the miss request to a second cache. The miss request comprises a physical address provided by the TLB and miss information provided by the hit/miss block. The first cache is further configured to receive, from the second cache, previously-stored metadata associated with an entry in the second cache. The entry in the second cache is associated with the miss request. The first cache may further include a synonym detection block, which is configured to identify a cache line in the first cache for invalidation based on the previously-stored metadata received from the second cache

### BACKGROUND

### I. Field of the Disclosure

The technology of the disclosure relates generally to synonym handling in cache memories, and specifically to just-in-time synonym handling for a virtually-tagged cache memory.

### II. Background

Microprocessors may conventionally include cache memories (for instructions, data, or both) in order to provide relatively low-latency storage (relative to a main memory coupled to the microprocessor) for information that may be used frequently during processing operations. Such caches may be implemented in multiple levels, having differing relative access latencies and storage capacities (for example, L0, L1, L2, and L3 caches, in some conventional designs). In order to more efficiently use the storage capacity of a cache, the cache may be addressed (tagged) by virtual address, rather than by physical address. This means that the processor may perform a lookup in such a cache directly with an untranslated virtual address (instead of first performing a lookup of the virtual address in a translation lookaside buffer, or TLB, for example, to determine a physical address), and thus, cache lookups may be relatively lower latency where implemented by virtual address (since the TLB lookup is not part of the access path).

However, if virtual addresses are used as tags for the cache, the possibility arises that two different virtual addresses that nevertheless translate to the same physical address may be stored in the cache at the same time. Such multiple copies are referred to as aliases or synonyms, and their presence can degrade cache performance. In the case of read performance from the cache, the presence of synonyms can degrade performance by taking up extra cache lines that could otherwise be used to store virtual addresses that translate to unique physical addresses, which means that less useful data can be stored in the cache at any time. In the case of write performance to the cache, the presence of synonyms can degrade performance by causing undesirable behavior or errors. If the writes to the different virtual addresses (but which point to the same physical address) are not tracked properly, the state of a program being executed on the processor may become indeterminate, since one virtual address expects the previous data to be stored at that physical location when performing a read, while a write to a second virtual address pointing to the same physical address has changed the underlying data.

Both hardware and software solutions exist which can mitigate the problems described above with synonyms in caches. However, implementations of those solutions impose costs in terms of hardware area and complexity, software overhead, or both, which may be undesirable or unworkable in particular designs. Thus, it would be desirable to implement a cache design that reduces the frequency at which synonyms occur.

### SUMMARY OF THE DISCLOSURE

Aspects disclosed in the detailed description include a cache configured to provide just-in-time synonym handling, and related apparatuses, systems, methods, and computer-readable media.

In this regard in one aspect, an apparatus includes a first cache comprising a translation lookaside buffer (TLB) and a hit/miss block. The first cache is configured to form a miss request associated with an access to the first cache and provide the miss request to a second cache. The miss request comprises a physical address provided by, the TLB and miss information provided by the hit/miss block. The first cache is further configured to receive, from the second cache, previously-stored metadata associated with an entry in the second cache. The entry in the second cache is associated with the miss request.

In another aspect an apparatus includes first means for caching, which comprises means for address translation and means for miss determination. The first means for caching is configured to form a miss request associated with an access to the first means for caching and provide the miss request to a second means for caching. The miss request comprises a physical address provided by the means for address translation and miss information provided by the means for miss determination. The first means for caching is further configured to receive, from the second means for caching, previously-stored metadata associated with an entry in the second means for caching. The entry in the second means for caching is associated with the miss request.

In yet another aspect a method includes providing a miss request, associated with an access to a first cache, to a second cache. The method further includes receiving previously-stored metadata associated with the entry identified in a second cache as being associated with the miss request at the first cache, in response to the miss request.

In yet another aspect, a non-transitory computer-readable medium stores computer executable instructions which, when executed by a processor, cause the processor to provide a miss request, associated with an access to a first cache, to a second cache. The instructions further cause the processor to receive previously-stored metadata associated with the entry identified in a second cache as being associated with the miss request at the first cache in response to the miss request.

### BRIEF DESCRIPTION OF THE FIGURES

FIG. 1 is a block diagram of an exemplary processor including a cache design configured to reduce the frequency of synonyms in the first-level cache;

FIG. 2 is a detailed block diagram of exemplary first-level and second-level caches configured to use synonym information to reduce the frequency of synonyms in the first-level cache;

FIG. 3a is a block diagram illustrating an exemplary miss request sent from a first-level cache to a second-level cache and including synonym information according to one aspect;

FIG. 3b is a block diagram illustrating an exemplary second level cache line that includes first-level cache synonym information, according to one aspect;

FIG. 4 is a flowchart illustrating a method of reducing the frequency of the occurrence of synonyms in a first-level cache; and

FIG. 5 is a block diagram of an exemplary processor-based system configured to reduce the frequency of synonyms in a first-level cache.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include a cache configured to provide just-in-time synonym handling, and related apparatuses, systems, methods, and computer-readable media.

In this regard in one aspect, an apparatus includes a first cache comprising a translation lookaside buffer (TLB) and a hit/miss block. The first cache is configured to form a miss request associated with an access to the first cache and provide the miss request to a second cache. The miss request comprises a physical address provided by the TLB and miss information provided by the hit/miss block. The first cache is further configured to receive, from the second cache, previously-stored metadata associated with an entry in the second cache. The entry in the second cache is associated with the miss request.

In another aspect an apparatus includes first means for caching, which comprises means for address translation and means for miss determination. The first means for caching is configured to form a miss request associated with an access to the first means for caching and provide the miss request to a second means for caching. The miss request comprises a physical address provided by the means for address translation and miss information provided by the means for miss determination. The first means for caching is further configured to receive, from the second means for caching, previously-stored metadata associated with an entry in the second means for caching. The entry in the second means for caching is associated with the miss request.

In yet another aspect a method includes providing a miss request, associated with an access to a first cache, to a second cache. The method further includes receiving previously-stored metadata associated with the entry identified in a second cache as being associated with the miss request at the first cache, in response to the miss request.

In yet another aspect, a non-transitory computer-readable medium stores computer executable instructions which, when executed by a processor, cause the processor to provide a miss request, associated with an access to a first cache, to a second cache. The instructions further cause the processor to receive previously-stored metadata associated with the entry identified in a second cache as being associated with the miss request at the first cache in response to the miss request.

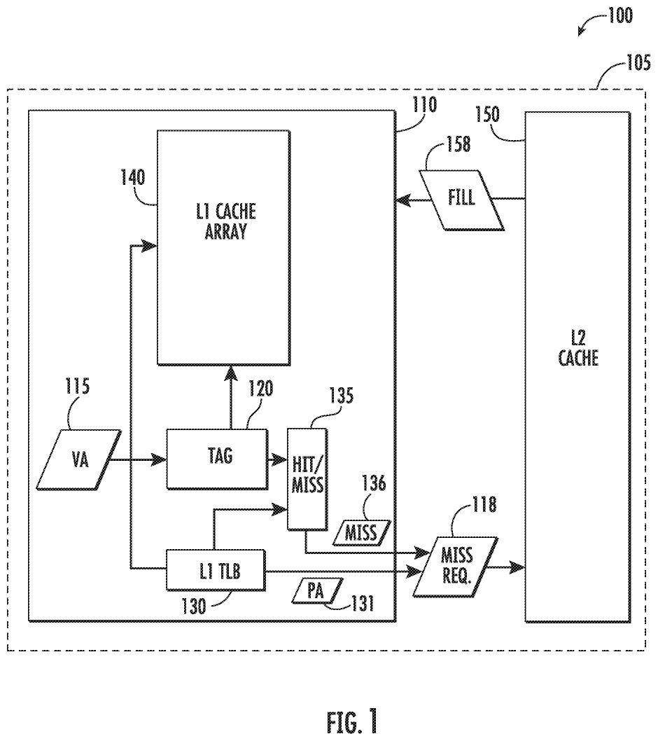

In this regard, FIG. 1 is a block diagram 100 of an exemplary processor 105 including a cache design configured to reduce the frequency of synonyms in a first-level cache of the exemplary processor 105. The processor 105 includes a first-level cache such as L1 data cache 110. The processor 105 further includes a second-level cache such as L2 cache 150. L2 cache 150 is inclusive of the L1 data cache 110 (i.e., each line that is resident in the L1 data cache 110 is also resident in the L2 cache 150, and if a line is invalidated in the L2 cache 150, it must also be invalidated in the L1 data cache 110). The L1 data cache 110 and the L2 cache 150 are coupled together, such that the L1 data cache 110 may provide requests (such as miss request 118) to the L2 cache 150 for the L2 cache 150 to service (or, alternatively, to provide to a higher level of memory hierarchy for service, as will be understood by those having skill in the art), and the L2 cache 150 may provide data and information (such as fill response 158) back to the L1 data cache 110.

In the illustrated aspect, the L1 data cache 110 is virtually-addressed, while the L2 cache 150 is physically addressed. On an access to the L1 data cache 110, a virtual address (VA) 115 is presented for data access, tag access, and address translation (i.e., translation lookaside buffer lookup) in parallel. The data access may be performed by an L1 cache array 140, while the tag lookup may be performed by a tag block 120. The address translation may be performed at an L1 TLB 130.

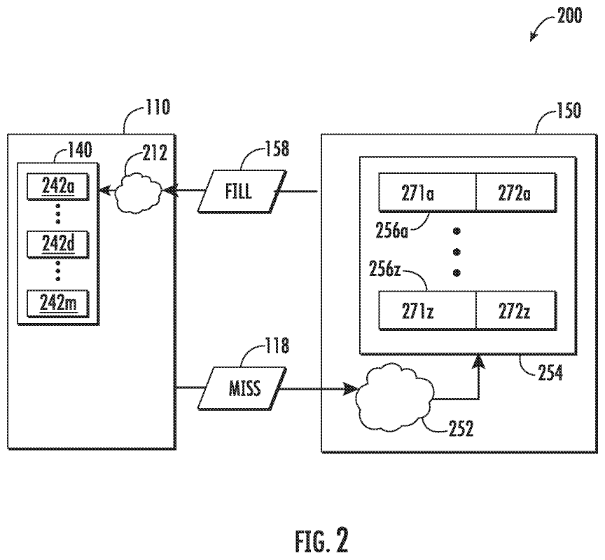

Both the tag block 120 and the L1 TLB 130 may be coupled to a hit/miss block 135 in order to provide hit/miss information to the hit/miss block 135, which will perform a final hit/miss determination for the access to the L1 data cache 110 associated with the VA 115 and will provide miss information 136, which may be used to form at least a portion of the miss request 118. As will be discussed in greater detail below, the miss information 136 may comprise synonym information, which may be one or more synonym bits, and which may be used by the L2 cache 150 to reduce the frequency of synonyms in the L1 data cache 150. The L1 TLB 130 may perform a lookup of the virtual address 115 in order to identify a physical address 131 associated with the virtual address 115. As described above, the L1 TLB 130 may provide TLB hit/miss information to the hit/miss block 135 to allow the hit/miss block 135 to perform the final hit/miss determination for the access to the L1 data cache 110 associated with the VA 115. The L1 TLB 130 may further provide the physical address 131, which may be used to form at least a portion of the miss request 118. Thus, the miss request 118 includes at least the physical address 131 and the miss information 136, which may include synonym information as will be further described with respect to FIG. 2.

The L2 cache 150 may service miss requests such as miss request 118 from the L1 data cache 110 by forming the fill response 158 and providing that fill response 158 back to the L1 data cache 110. In the case of a miss request where the data cache 110 does not contain a synonym, the L2 cache 150 may include the data (in one aspect, the cache line) requested by the miss request 118 in the fill response 158, and may update synonym information stored in the L2 cache 150 in a line associated with the miss request 118. This synonym information may include, for example, the fact that the L2 cache has provided the requested line to the L1 data cache 150 (i.e., that the requested line is now resident in the L1 data cache 150). As will be described below, further information may be stored in the requested line in the L2 cache 150 that more precisely describes the synonym.

In the case of a miss request where the L1 data cache 110 does contain a synonym, the L2 cache 150 may include the data requested by the miss request 118 and an indication of where a synonym of the requested cache line may be stored in the L1 data cache 110 in the fill response 158 so that the L1 data cache 110 may invalidate the synonym of the requested cache line, and may update synonym information stored in the L2 cache 150 in a line associated with the miss request where appropriate to reflect the updated location of the requested data in the L1 data cache 110. Invalidating the synonym of the requested line associated with the miss request 118 allows later writes to the L1 data cache 110 to proceed directly in the case of a hit in the L1 data cache 110, as doing invalidations in this way guarantees that the cache does not allow conflicting writes to the same physical address (and thus potentially cause the processor state to become indeterminate).

Moreover, the L2 cache 150 is not required to update the synonym information to indicate when a line in the L2 cache 150 is no longer resident in the L1 data cache 110 (i.e., all copies of it in the L1 data cache 110 have been invalidated)—not doing so may cause some performance loss, as the L1 data cache 110 may attempt to find a line to invalidate that is not currently resident, but this will not cause unpredictable processor states to occur. Thus, the synonym information maintained in the L2 cache 150 may exhibit false positive behavior (i.e., indicate that a line may be present in the lower level cache when it is not present), but may not exhibit false negative behavior (i.e., indicate that a line is not present in a lower level cache when it is in fact present).

In order to provide further explanation regarding some aspects, FIG. 2 provides a detailed block diagram 200 of exemplary first-level and second-level caches configured to use synonym information to reduce the frequency of synonyms in the first-level cache. The first-level cache may be the L1 data cache 110 of FIG. 1 and the second-level cache may be the L2 cache 150 of FIG. 1, for example. As described with reference to FIG. 1, the L1 data cache 110 may have an L1 cache array 140 that stores L1 cache lines 242a-m, and may provide miss requests such as miss request 118 to the L2 cache 150 for servicing. The L2 cache 150 may provide fill responses in response to the miss request 118, such as fill response 158.

The L2 cache 150 includes an L2 cache array 254. The L2 cache array 254 includes a plurality of L2 cache lines 256a-z. Each of the L2 cache lines 256a-z includes a data portion 271a-z and a synonym information portion 272a-z. The L2 cache 150 further includes a miss request service block 252, which may provide synonym information derived from the miss request 118 that may be used during a lookup of the L2 cache array 254, based on physical address information received from the L1 data cache 110 in the miss request 118. Additionally, the L1 data cache 110 may further include a synonym detection block 212, which is responsive to synonym information received as part of the fill response 158 and is configured to locate and invalidate a synonym of physical address associated with the miss request 118 which generated the fill response 158.

Any particular implementation of the L1 data cache 110 including the synonym detection block 212 and the L2 cache 150 may be thought of as a trade-off between the area and complexity of the synonym detection block 212 in the L1 data cache 110, and the size and area consumed by the synonym information portions 272a-z of the L2 cache 150. In one aspect, the synonym information may be minimal; for example, the L1 data cache 110 may send only an indication that a particular physical address has missed in the L1 cache along with the physical address in the miss request 118, and thus the L2 cache 150 may store only an indication of whether or not the L2 cache 150 has previously mitten that line to the L1 data cache 110, but no further location information (i.e., a “present” indicator), in the synonym information portion 272 of the associated line 256. In such an aspect, the amount of storage added to the L2 cache 150 to accommodate synonym information is relatively small. However, in such an aspect, the synonym detection block 212 may be relatively more complex, as it will need to be able to conduct a lookup of the entire L1 data cache array 140 in order to locate the synonym in order to invalidate it (or, in the case where the synonym information in the L2 cache 150 exhibits false positive behavior, determine that the synonym is not present in the L1 data cache 110).

Conversely, in another aspect, the L1 data cache 110 may send some number of virtual address bits (e.g., bits [13:12] in a system having minimum 4 KB page sizes and 256 sets in the L1 data cache 110, since in such a system bits [11:6] are untranslated) indicating a more specific location that was looked up in the L1 data cache 110 in addition to the physical address in the miss request 118, and the L2 cache 150 may store those bits in the synonym information portion 272 of the associated line 256. In such an aspect, the amount of area devoted to the storage of synonym information in the L2 cache 150 is greater relative to the previous aspect, but the synonym detection block 212 may be reduced in complexity because the L2 cache 150 can provide more specific location information back to the L1 data cache 110 as part of the fill response 158.

Moreover, in yet another aspect, the L1 data cache 110 may send the specific set and way information for the miss in addition to the physical address in the miss request 118, and the L2 cache 150 may store the full set and way information in the synonym information portion 272 of the associated line 256. In such an aspect, the amount of area devoted to the storage of synonym information in the L2 cache 150 is greater yet again than in the previous two aspects, but the synonym detection block 212 may be yet again relatively less complex, as it receives complete way and set information from the L2 cache 150 as part of the fill response 158, and need only perform an invalidation on the indicated way and set instead of needing to perform any degree of lookup in the L1 cache array 140.

Those having skill in the art will recognize that other kinds of synonym information may be provided as part of the miss request 118, and that the specific choice of which and how much synonym information to provide is a design choice that will be influenced by many factors. Such factors may include, but are not limited to, available die area for the L1 and L2 caches, desired performance of the L1 and L2 caches, bandwidth available to devote to inter-cache signaling (i.e., how large to make the miss requests and fill responses), and other similar considerations which will be readily apparent to the designer. All of these are explicitly within the scope of the teachings of the present disclosure.

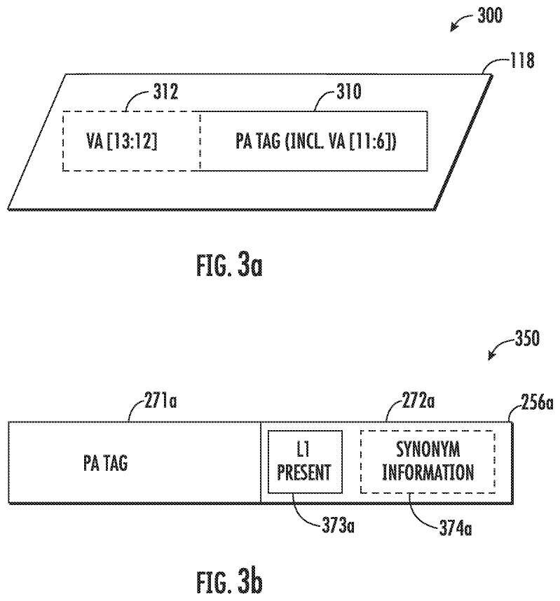

FIG. 3a is a block diagram 300 illustrating an exemplary miss request sent from a first-level cache to a second-level cache and including synonym information according to one aspect. The miss request may be the miss request 118 of FIG. 1, for example. The miss request 118 includes at least the physical address 310 that was associated with a virtual address which missed in the first-level cache (such as the VA 115 in the L1 data cache 110). Because the second-level cache is physically addressed, providing the physical address 310 computed by the L1 TLB allows the second-level cache to immediately perform a lookup based on that address.

The miss request 118 also includes miss information 312. As discussed above with reference to FIG. 2, the miss information 312 may further include synonym information regarding an expected location for the physical address associated with the virtual address looked up in the first-level cache. In the illustrated aspect, the miss information 312 includes bits [13:12] of the virtual address looked up in the first-level cache. The miss information 312 may be used by the L2 cache 150 in servicing the miss request 118.

FIG. 3b is a block diagram 350 illustrating an exemplary second level cache line that includes first-level cache synonym information, according to one aspect. The exemplary second level cache line may be cache line 256a of FIG. 2, for example. The cache line 256a includes a data portion 271a, which may include a physical address, and which is how the cache line 256a may be looked up.

The cache line 256a further includes the synonym information portion 272a. In one aspect, this may be an L1 present indicator 373a, which may indicate simply that the L2 cache 150 has previously written the cache line 256a to the L1 data cache 110. The synonym information portion 272a may further include more detailed synonym information 374a. In one aspect, the synonym information 374a may be virtual address bits [13:12] as described in reference to FIG. 3a. In another aspect, the synonym information 374 may be complete way and set information as described earlier with respect to FIG. 2. The above-described aspects regarding synonym information are provided merely by way of illustration and not by way of limitation, and those having skill in the art will recognize that other types of synonym information may be used, and such other types of synonym information are within the scope of the teachings of the present disclosure.

In operation, the L2 cache 150 may perform a lookup of the physical address 310, and may determine whether or not that physical address has previously been written to the L1 data cache 110 by examining the L1 present indicator 373a and/or the synonym information 374a. If the L2 cache 150 determines that the cache line 256a has been previously written to the L1 data cache 110, the L2 cache 150 may provide the existing synonym information as part of the fill response 158 so that the L1 data cache 110 may invalidate the cache line 2′42a-m that contains the synonym of the physical address 310 as discussed with reference to FIG. 2 (assuming that such line has not already been invalidated, as discussed previously). Optionally, the L2 cache 150 may update the synonym information portion 272a in response to the miss request 118 by changing the synonym information 374a to reflect the miss information 312 received in the miss request 118.

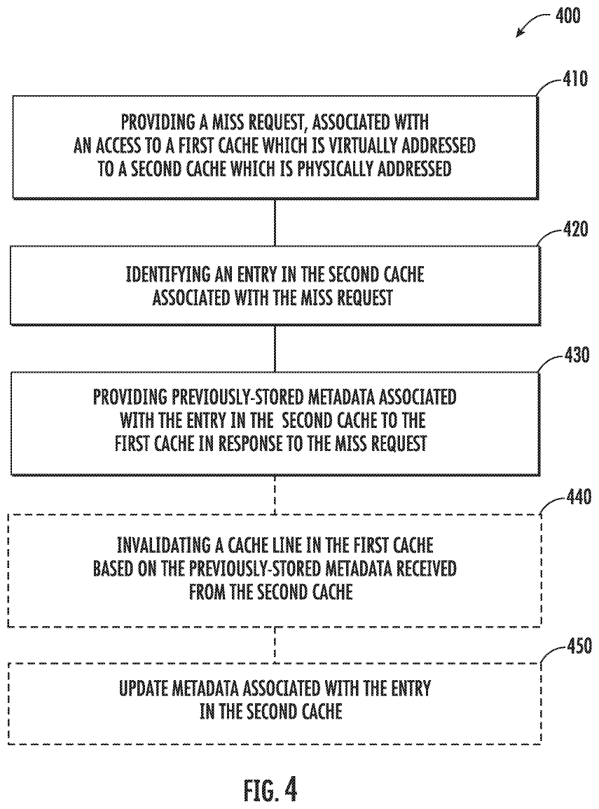

FIG. 4 is a flowchart illustrating a method 400 of reducing the frequency of the occurrence of synonyms in a first-level cache. The method may be performed by the data cache 110 and the L2 cache 150 of FIGS. 1 and 2. The method begins at block 410, where a miss request associated with an access to a first cache is provided to a second cache. The first cache is virtually addressed, and the second cache is physically addressed. For example, in FIG. 1, the miss request 118 is provided from the virtually addressed L1 cache 110 to the physically addressed L2 cache 150.

The method continues at block 420, where an entry in the second cache that is associated with the miss request is identified. For example, cache line 256a may be identified as being associated with the miss request 118, as in FIGS. 2 and 3. The method further includes providing previously-stored metadata associated with the entry in the second cache to the first cache, in response to the miss request. For example, the L2 cache 150 may provide information previously stored in the synonym information portion 272a of cache line 256a as part of the fill response 158 to the L1 data cache 110.

The method 400 may further comprise invalidating a cache line in the first cache based on the previously-stored metadata received from the second cache. For example, the synonym detection block 212 may receive the fill response 158 which contains previously-stored metadata such as the L1 present indicator 373a and/or the synonym information 374a of FIG. 3. The synonym detection block 212 may use the previously-stored metadata to locate the synonym and, if the synonym is located, perform an invalidation of the synonym in one of cache lines 242a-m associated with the miss request 118.

The method 400 may further comprise updating metadata associated with the entry in the second cache. For example, the synonym information 374a of cache line 256a of L2 cache 150 may be updated based on the miss information 312 received in the miss request 118.

Those having skill in the art will recognize that the choice of specific cache types in the present aspect are merely for purposes of illustration, and not by way of limitation, and the teachings of the present disclosure may be applied to other cache types (such as instruction caches), and at differing levels of the cache hierarchy (e.g., between an L2 and an L3 cache), as long as the higher-level cache is inclusive of the lower-level cache in question, and the lower-level cache is virtually addressed while the higher-level cache is physically addressed (i.e., the lower-level cache can exhibit synonym behavior, while the higher-level cache does not). Furthermore, those having skill in the art will recognize that certain blocks have described with respect to certain functions, and that these functions may be performed by other types of blocks, all of which are within the scope of the teachings of the present disclosure. For example, as discussed above, various levels and types of caches are specifically within the scope of the teachings of the present disclosure, and may be referred to as means for caching. Various hardware and software blocks that are known to those having skill in the art may perform the function of the L1 TLB 130, and may be referred to as means for translation, and similar blocks which perform hit or miss determinations such as hit/miss block 135 may be referred to as means for miss determination. Likewise, other hardware or software blocks that perform a similar function to synonym detection block 212 may be referred to as means for synonym detection. Additionally, specific functions have been discussed in the context of specific hardware blocks, but the assignment of those functions to those blocks is merely exemplary, and the functions discussed may be incorporated into other hardware blocks without departing from the teachings of the present disclosure.

The exemplary processor including a cache design configured to reduce the frequency of synonyms in a first-level cache according to aspects disclosed herein may be provided in or integrated into any processor-based device. Examples, without limitation, include a server, a computer, a portable computer, a desktop computer, a mobile computing device, a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a wearable computing device (e.g., a smart watch, a health or fitness tracker, eyewear, etc.), a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

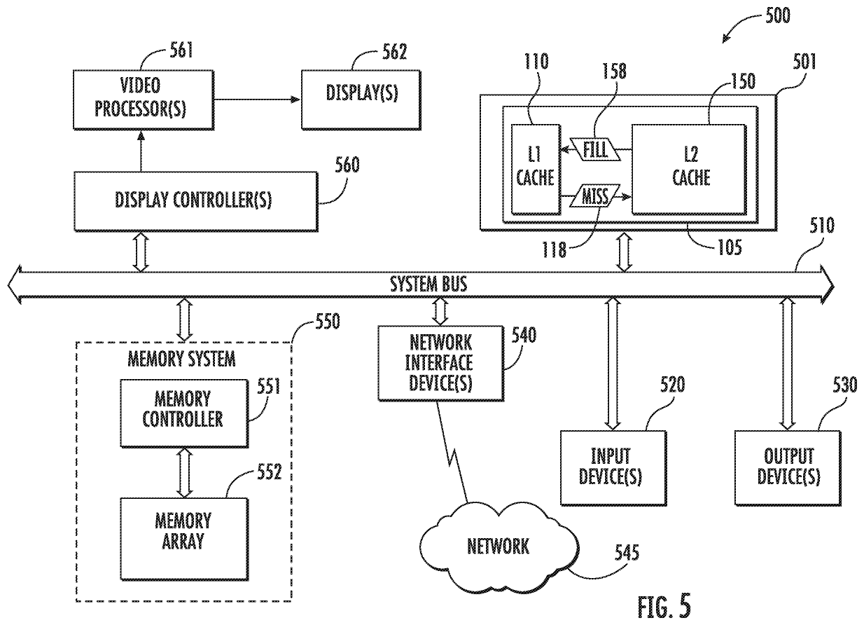

In this regard, FIG. 5 illustrates an example of a processor-based system 500 that can reduce the frequency of synonyms in a first-level cache illustrated and described with respect to FIGS. 1-4. In this example, the processor-based system 500 includes a processor 501 having one or more central processing units (CPUs) 505, each including one or more processor cores, and which may correspond to the processor 105 of FIG. 1, and as such may include the L1 data cache HO and L2 cache 150 of FIG. 1, and which may be configured to service miss requests such as miss request 118 and provide fill responses such as fill response 158. The CPU(s) 505 may be a master device. The CPU(s) 505 may have cache memory 508 coupled to the CPU(s) 505 for rapid access to temporarily stored data. The CPU(s) 505 is coupled to a system bus 510 and can intercouple master and slave devices included in the processor-based system 500. As is well known, the CPU(s) 505 communicates with these other devices by exchanging address, control, and data information over the system bus 510. For example, the CPU(s) 505 can communicate bus transaction requests to a memory controller 551 as an example of a slave device. Although not illustrated in FIG. 5, multiple system buses 510 could be provided, wherein each system bus 510 constitutes a different fabric.

Other master and slave devices can be connected to the system bus 510. As illustrated in FIG. 5, these devices can include a memory system 550, one or more input devices 520, one or more output devices 530, one or more network interface devices 540, and one or more display controllers 560, as examples. The input device(s) 530 can include any type of input device, including, but not limited to, input keys, switches, voice processors, etc. The output device(s) 520 can include any type of output device, including, but not limited to, audio, video, other visual indicators, etc. The network interface device(s) 540 can be any devices configured to allow exchange of data to and from a network 545. The network 545 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 540 can be configured to support any type of communications protocol desired. The memory system 550 can include the memory controller 551 coupled to one or more memory units 552.

The CPU(s) 505 may also be configured to access the display controller(s) 560 over the system bus 510 to control information sent to one or more displays 562. The display controller(s) 560 sends information to the display(s) 562 to be displayed via one or more video processors 561, which process the information to be displayed into a format suitable for the display(s) 562. The display(s) 562 can include any type of display, including, but not limited to, a cathode ray tube (CRT), a liquid crystal display (LCD), a plasma display, a light emitting diode (LED) display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The master devices and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

What is claimed is:

1. An apparatus, comprising:
a first cache comprising a translation lookaside buffer (TLB) and a hit/miss block;
wherein the first cache is configured to form a miss request associated with an access to the first cache and provide the miss request to a second cache, the miss request comprising a physical address provided by the TLB and miss information provided by the hit/miss block; and
wherein the first cache is further configured to receive, from the second cache, previously-stored metadata associated with an entry in the second cache, the entry in the second cache associated with the miss request.

2. The apparatus of claim 1 further comprising a synonym detection block, wherein the synonym detection block is configured to identify a cache line in the first cache for invalidation based on the previously-stored metadata received from the second cache.

3. The apparatus of claim 2; wherein the first cache is further configured to invalidate the cache line in the first cache identified by the synonym detection block.

4. The apparatus of claim 1, wherein the previously-stored metadata associated with the entry in the second cache comprises a “present in first cache” indicator.

5. The apparatus of claim 4, wherein the previously-stored metadata associated with the entry in the second cache comprises at least one synonym bit of a virtual address.

6. The apparatus of claim 4, wherein the previously-stored metadata associated with the entry in the second cache identifies a set and a way of the first cache that may contain an entry associated with the miss request.

7. The apparatus of claim 1, wherein the previously-stored metadata may erroneously indicate that a cache line associated with the miss request is present in the first cache, but may not erroneously indicate that a cache line associated with the bliss request is not present in the first cache.

8. The apparatus of claim 1, wherein the second cache is configured to update the previously-stored metadata associated with the entry of the second cache, based on the miss request associated with the entry of the second cache.

9. The apparatus of claim 8, wherein the miss request comprises synonym information, and updating the previously-stored metadata comprises replacing the previously-stored metadata with the synonym information from the miss request.

10. The apparatus of claim 1, integrated into an integrated circuit (IC).

11. The apparatus of claim 10, further integrated into a device selected from the group consisting of: a server, a computer, a portable computer, a desktop computer, a mobile computing device, a set top box, an entertainment unit, a navigation device, a communications device, a fixed location data unit, a mobile location data unit, a global positioning system (UPS) device, a mobile phone, a cellular phone, a smart phone, a session initiation protocol (SIP) phone, a tablet, a phablet, a wearable computing device (e.g., a smart watch, a health or fitness tracker, eyewear, etc.), a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

12. An apparatus, comprising:
first means for caching, comprising means for address translation and means for miss determination;
wherein the first means for caching is configured to form a miss request associated with an access to the first means for caching and provide the miss request to a second means for caching, the miss request comprising a physical address provided by the means for address translation and miss information provided by the means for miss determination; and
wherein the first means for caching is further configured to receive, from the second means for caching, previously-stored metadata associated with an entry in the second means for caching, the entry in the second means for caching associated with the miss request.

13. The apparatus of claim 12 further comprising means for synonym detection, wherein the means for synonym detection is configured to identify a cache line in the first means for caching for invalidation based on the previously-stored metadata received from the second means for caching.

14. A method, comprising:
providing a miss request, associated with an access to a first cache, to a second cache; and
receiving previously-stored metadata associated with the entry identified in a second cache as being associated with the miss request at the first cache, in response to the miss request.

15. The method of claim 14, further comprising identifying a cache line of the first cache for invalidation based on the previously-stored metadata from the second cache.

16. The method of claim 15, further comprising invalidating the cache line of the first cache identified by the synonym detection block.

17. The method of claim 14, wherein the previously-stored metadata associated with the entry in the second cache comprises a “present in first cache” indicator.

18. The method of claim 16, wherein the previously-stored metadata associated with the entry in the second cache comprises at least one synonym bit of a virtual address.

19. The method of claim 16, wherein the previously-stored metadata associated with the entry in the second cache identifies a set and a way of the first cache that may contain an entry associated with the miss request.

20. The method of claim 14, wherein the previously-stored metadata may erroneously indicate that a cache line associated with the miss request is present in the first cache, but may not erroneously indicate that a cache line associated with the miss request is not present in the first cache.

21. The method of claim 14, further comprising updating the previously-stored metadata associated with the entry identified in the second cache by replacing the previously-stored metadata with information from the miss request.

22. A non-transitory computer-readable medium having stored thereon computer executable instructions which, when executed by a processor, cause the processor to:
provide a miss request, associated with an access to a first cache, to a second cache; and
receive previously-stored metadata associated with the entry identified in a second cache as being associated with the miss request at the first cache in response to the miss request.

23. The non-transitory computer-readable medium of claim 22, having stored thereon further computer executable instructions which, when executed by a processor, cause the processor to:
identify a cache line of the first cache for invalidation based on the previously-stored metadata from the second cache.
